(19) United States
(12) Patent Application Publication
(10) Pub. No.: US 2020/0319786 A1
(43) Pub. Date: Oct. 8, 2020

(54) VEHICULAR DISPLAY APPARATUS AND DISPLAYING METHOD

(71) Applicant: DENSO CORPORATION, Kariya-city (JP)

(72) Inventors: Masaru SAWAKI, Kariya-city (JP); Ichiro YOSHIDA, Kariya-city (JP)

(21) Appl. No.: 16/908,238

(22) Filed: Jun. 22, 2020

Related U.S. Application Data
(63) Continuation of application No. PCT/JP2018/037406, filed on Oct. 5, 2018.

(30) Foreign Application Priority Data
Dec. 28, 2017 (JP) 2017-253499

(51) Int. Cl. G06F 3/0484; G06F 3/0482

(52) U.S. Cl. CPC G06F 3/04847; G06F 3/0482

(57) ABSTRACT

In a vehicular display apparatus, in response to that a rotation operation is detected, a view of a plurality of items displayed on a circular ring-shaped second display area is rotated along the outer periphery of a circle-shaped first display area. An item displayed at a predetermined position among the plurality of items displayed on the second display area is determined as a processing target item. Processing is executed for inputting a character on a character input screen on the first display area according to the determined processing target item.

### CROSS REFERENCE TO RELATED APPLICATIONS

The present application is a continuation application of International Patent Application No. PCT/JP2018/037406 filed on Oct. 5, 2018, which designated the U.S. and claims the benefit of priority from Japanese Patent Application No. 2017-253499 filed on Dec. 28, 2017. The entire disclosures of all of the above applications are incorporated herein by reference.

### TECHNICAL FIELD

The present disclosure relates to a vehicular display apparatus and a displaying method.

### BACKGROUND

For instance, a character input apparatus is provided to permit a user to input a character with a pointing device such as a mouse or a trackball to display the inputted character. Further, a character input apparatus is provided to permit a user to input a character by operating a touch panel to display the inputted character. This type of character input apparatus displays a rectangular array of a list of characters that can be inputted, such as Japanese (syllabary), alphabets, symbols, numbers. When the user selects a character, the selected character can be inputted. In contrast, a circle-shaped display may be used for a display apparatus.

### SUMMARY

According to an example of the present disclosure, in a vehicular display apparatus, in response to that a rotation operation is detected, a view of a plurality of items displayed on a circular ring-shaped second display area is rotated along the outer periphery of a circle-shaped first display area. An item displayed at a predetermined position among the plurality of items displayed on the second display area is determined as a processing target item. Processing is executed for inputting a character on a character input screen on the first display area according to the determined processing target item.

### BRIEF DESCRIPTION OF DRAWINGS

The objects, features and advantages of the present disclosure will become more apparent from the following detailed description made with reference to the accompanying drawings. In the drawings:

FIG. 1 is a functional block diagram showing one embodiment;

FIG. 2 is a diagram showing an example of displaying a mail screen view and various icons;

FIG. 3 is a diagram showing an example of displaying a map screen view and various icons;

FIG. 4 is a diagram illustrating an example in which a rotation operation is performed during the display of the mail screen view;

FIG. 5 is a diagram illustrating an example in which a rotation operation is performed during the display of the map screen view;

FIG. 6 is a diagram showing an example in which a processing target item is determined during the display of the mail screen view;

FIG. 7 is a diagram showing an example in which a reply screen view is displayed;

FIG. 8 is a diagram illustrating am example in which a processing target item is determined during the display of the map screen view;

FIG. 9 is a diagram showing an example in which the destination setting screen view is displayed;

FIG. 10 is a flowchart showing an application monitoring process;

FIG. 11 is a flowchart showing a process under application activation;

FIG. 12 is a diagram (part 1) illustrating a character input screen view and an example of displaying various characters; and

FIG. 13 is a diagram (part 2) illustrating a character input screen view and an example of displaying various characters.

### DETAILED DESCRIPTION

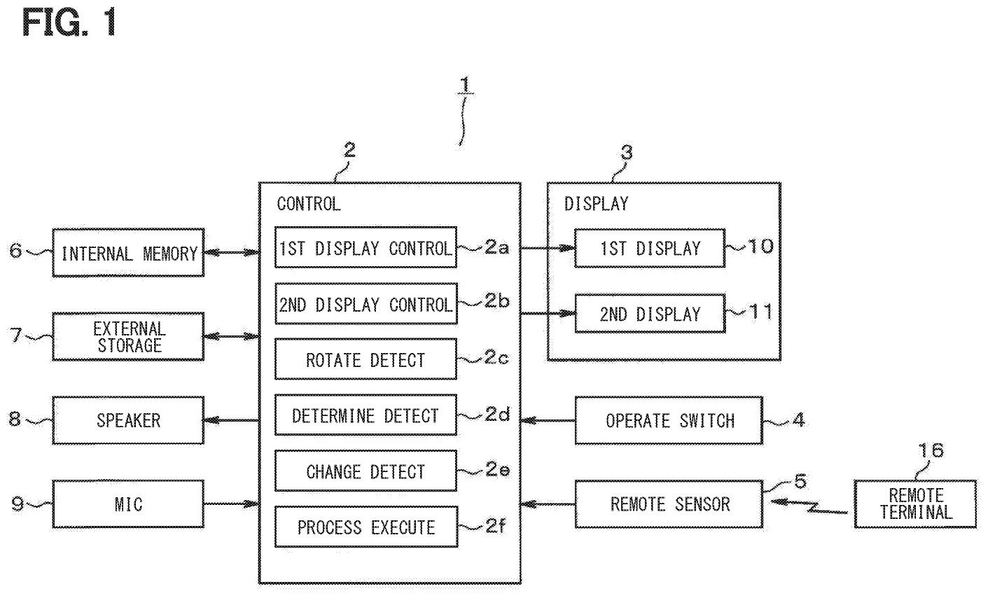

Hereinafter, an embodiment will be described with reference to the drawings. A vehicular display apparatus 1 is an apparatus that is mounted at a position where a driver can operate the apparatus while sitting in a driver's seat in a vehicle cabin. As shown in FIG. 1, the vehicular display apparatus 1 includes a controller 2, a display 3, an operation switch 4, a remote control sensor 5, an internal memory 6, an external storage 7, a speaker 8, and a microphone 9. Here, the controller 2 is communicatively connected with the display 3, the operation switch 4, the remote control sensor 5, the internal memory 6, the external storage 7, the speaker 8, and the microphone 9, via a communication link. The controller 2 switches the state of the vehicular display apparatus 1 by detecting ON/OFF of an accessory signal. When the accessory signal is switched from OFF to ON, the vehicular display apparatus 1 is shifted from the stopped state to the activated state. When the accessory signal is switched from ON to OFF, the vehicular display apparatus 1 is shifted from the activated state to the stopped state.

The controller 2, which may also be referred to as a processor, may be configured to be a microcomputer (i.e., computer). As one example of the present embodiment, such a microcomputer will be described as including a CPU (Central Processing Unit), a ROM (Read Only Memory), a RAM (Random Access Memory), and an I/O (Input/Output). The controller 2 (i.e., the microcomputer) executes processing corresponding to a computer program by executing the computer program stored in the non-transitory tangible storage medium, and controls the overall operation of the vehicular display apparatus 1.

Further, the functions executed by the controller 2 may be achieved by one or more controllers 2 (i.e., one or more processors), or one or more computers.

The computer program executed by the controller 2 includes a displaying program executing a displaying method.

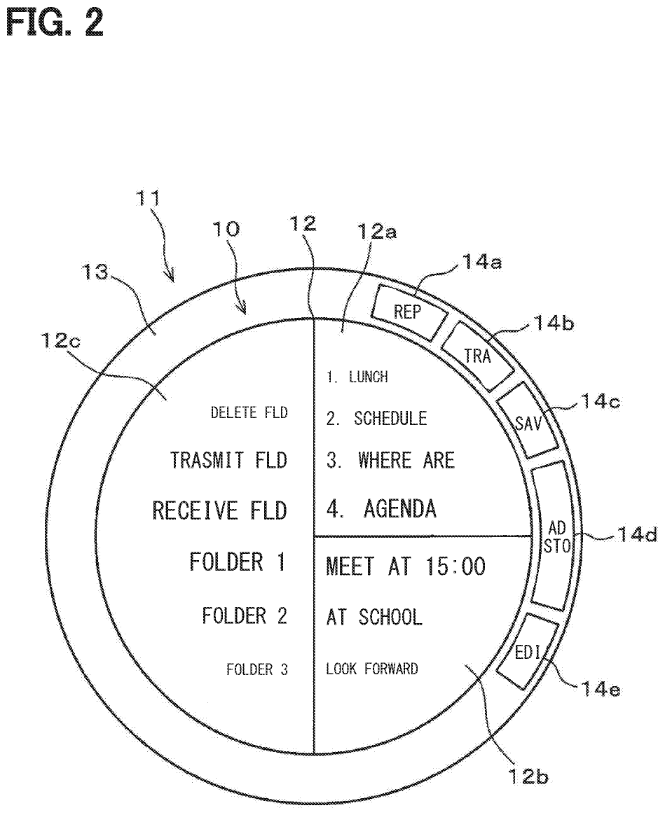

The display 3 includes a first display unit 10 and a second display unit 11, as shown in FIG. 2. The first display unit 10 has a circle-shaped first display area 12 as a display screen. The first display area 12 is divided into three display areas 12a to 12c: an upper right display area 12a, a lower right display area 12b, and a left display area 12c. When a first display command signal is inputted from the controller 2, the first display unit 10 displays the first display information, which is specified by the inputted first display command signal, on the first display area 12. For example, when a mail application is activated, the first display unit 10 displays a mail screen view on the first display area 12 as the first display information. A list of e-mail subjects is displayed on the upper right display area 12a, the text of the e-mail is displayed on the lower right display area 12b, and a list of folders (FLDs) is displayed on the left display area 12c. In this case, the first display unit 10 displays, on a center side, the character size to be relatively large to make the density on characters relatively small. The first display unit 10 displays, on a peripheral side, the size of the characters to be relatively small to make the density on characters relatively large. That is, the user can more easily recognize the information displayed on the center side than the information displayed on the peripheral side of the first display unit 10 (i.e., the first display area 12).

The second display unit 11, which is provided concentrically with the first display unit 10, has a circular ring-shaped second display area 13 as a display screen to surround the outer peripheral of the first display unit 10. The second display unit 11 receives a second display command signal from the controller 2 and then displays the second display information specified by the received second display command signal on the second display area 13. For example, when the mail application is activated, the second display unit 11 displays, on the second display area 13, several icons indicating operations that can be performed by the user on the mail screen view as the second display information. The icons include a reply icon 14a (REP), a transfer icon 14b (TRA), a save icon 14c (SAV), an address storage icon 14d (AD STO), and an edit icon 14e (EDI), as shown in FIG. 2. The icons indicating the operations that can be performed by the user on the mail screen view are not limited to the icons 14a to 14e described above.

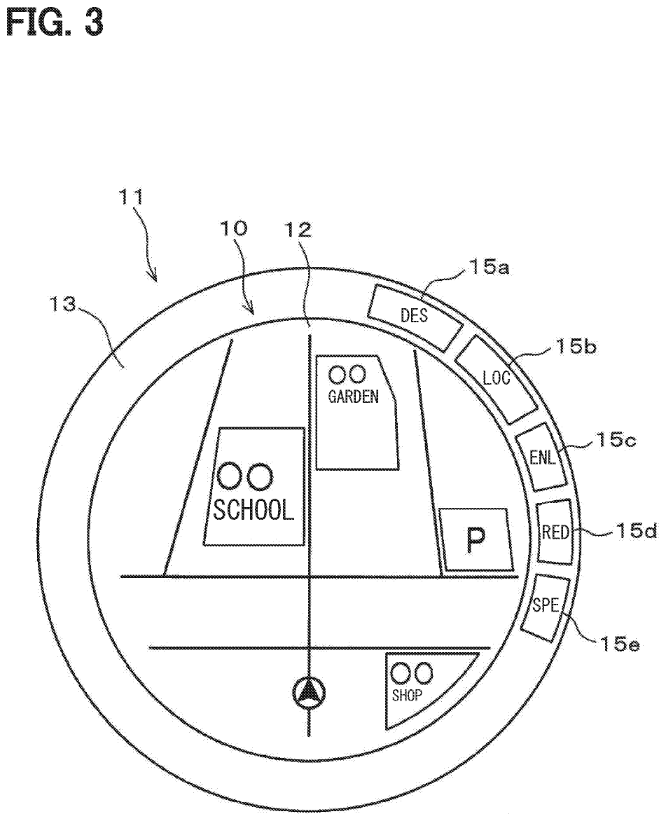

FIG. 2 illustrates a case where, for example, a mail application is activated, a mail screen view is displayed as the first display information, and icons 14a to 14e corresponding to the mail screen view are displayed as the second display information. For example, when the navigation application is activated, the display 3 displays a map screen view as the first display information and displays icons 15a to 15e corresponding to the map screen view as the second display information, as shown in FIG. 3. That is, the first display unit 10 displays the map screen view over the entire first display area 12, and displays a destination icon 15a (DES), a current location icon 15b (LOC), and an enlargement icon 15c (ENL), a reduction icon 15d (RED), a speech icon 15e (SPE), which indicate operations that can be performed by the user onto the map screen view, on the second display area 13, as shown in FIG. 3. In this case, the first display unit 10 relatively increases the scale of the image on the center side to relatively decrease the density on images, while relatively decreasing the scale of the image on the peripheral side to relatively increase the density on images. The icons indicating the operations that can be performed by the user onto the map screen view are not limited to the icons 15a to 15e described above. Note that increasing the scale of a map is equivalent to zooming the map in (i.e., covering narrower area); decreasing the scale of a map is equivalent to zooming the map out (i.e., covering wider area).

The operation switch 4 is a touch panel provided in the first display area 12 of the first display unit 10 and the second display area 13 of the second display unit 11. For example, when the user touches the first display area 12 to perform a screen change operation, the operation switch 4 outputs a screen operation detection signal that can specify the screen change operation to the controller 2. Upon receiving the screen operation detection signal from the operation switch 4, the controller 2 specifies a screen change operation on the first display area 12 by the received screen operation detection signal. The first display command signal corresponding to the specified screen change operation is then outputted to the first display unit 10.

In this case, upon receiving the first display command signal from the controller 2, the first display unit 10 switches or changes the display screen view according to the received first display command signal. That is, when the user performs a drag operation as a screen change operation while the mail screen view illustrated in FIG. 2 is displayed, the first display unit 10 switches the mail screen view according to the drag operation. Further, when the user performs a drag operation as a screen change operation while the map screen view shown in FIG. 3 is displayed, the first display unit 10 switches the map screen view according to the drag operation. The above has described the case where the user performs the drag operation as the screen change operation. The same applies when the user performs a tap operation, a double-tap operation, a flick operation, a pinch-in operation, a pinch-out operation, or the like as a screen change operation. The first display unit 10 switches the display screen view according to each screen change operation.

Further, for example, when the user touches the second display area 13 to perform a rotation operation, the operation switch 4 outputs a rotation operation detection signal capable of specifying the rotation operation to the controller 2. When the rotation operation detection signal is received from the operation switch 4, the controller 2 specifies a rotation operation on the second display area 13 based on the received rotation operation detection signal. The second display command signal corresponding to the specified rotation operation is outputted to the second display unit 11.

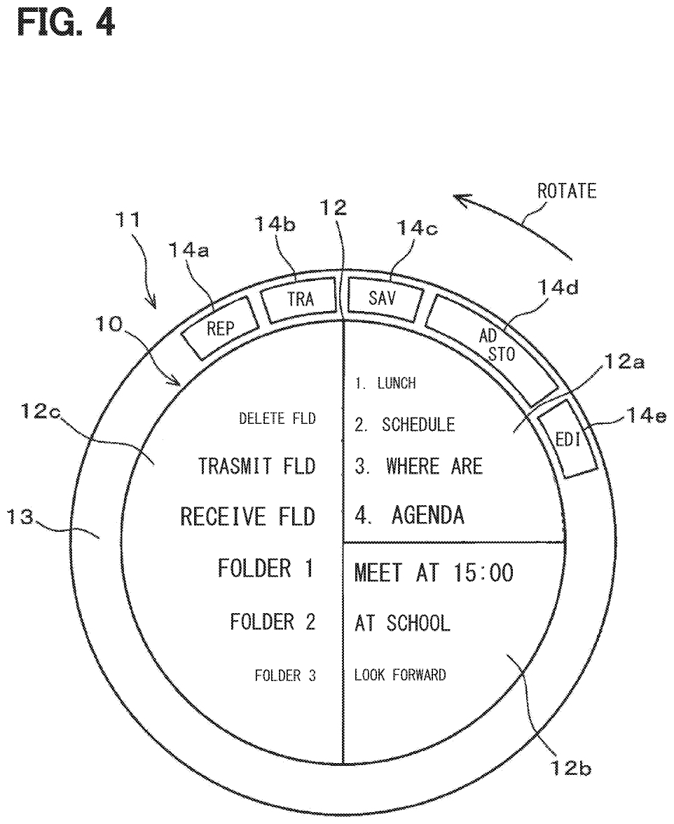

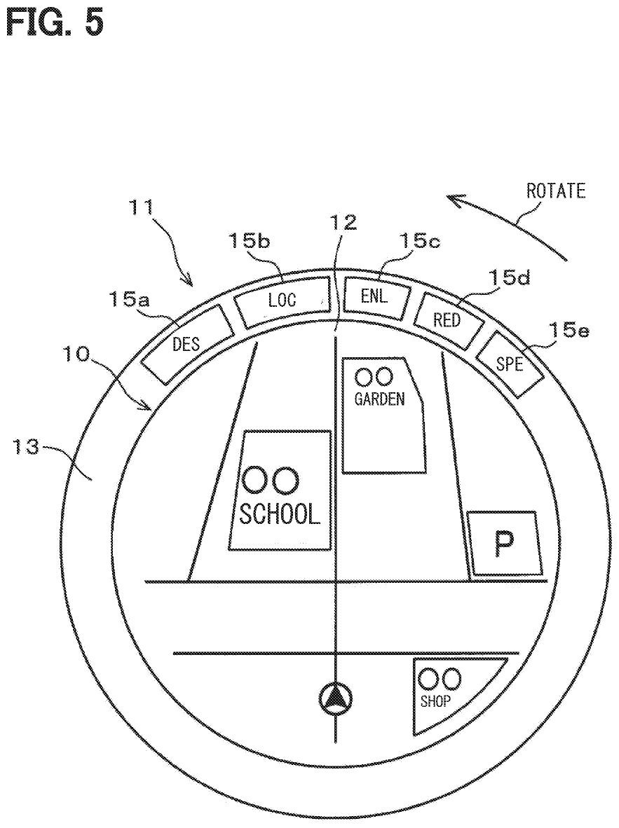

In this case, when the second display command signal is received from the controller 2, the second display unit 11 rotates the view (i.e., display) of the icons on the second display area 13 according to the received second display command signal. That is, when the user performs a rotation operation while the mail screen view is displayed as illustrated in FIG. 2, the second display unit 11 rotates the positions of the icons 14a to 14e in the second display area 13 according to the rotation operation, as shown in FIG. 4. When the user performs a rotation operation while the map screen view shown in FIG. 3 is displayed, the second display unit 11 rotates the positions of the icons 15a to 15e in the second display area 13 according to the rotation operation, as shown in FIG. 5. FIGS. 4 and 5 illustrate a case where the user performs a rotation operation in the counterclockwise direction. The direction in which the user performs the rotation operation may be either the clockwise direction or the counterclockwise direction.

The remote control terminal 16 is provided separately from the vehicular display apparatus 1. When the user operates the remote control terminal 16, an operation detection signal capable of specifying the operation content is transmitted to the remote control sensor 5 by wireless communication such as WiFi (registered trademark) or Bluetooth (registered trademark). When receiving the operation detection signal from the remote control terminal 16, the remote control sensor 5 outputs the received operation detection signal to the controller 2. The remote control terminal 16 is configured to be capable of performing a plurality of operations such as a long press, a short press, a movement in eight directions (up, down, left, right, and diagonally).

The internal memory 6 and the external storage 7 are configured to be able to store various databases and the like. The controller 2 outputs a read signal to the internal memory 6 or the external storage 7. The storage information specified by the read signal is thereby read out from the storage information stored in the internal memory 6 or the external storage 7. The read storage information is displayed on the display 3. That is, when activating the mail application, the controller 2 outputs a mail information read signal to the internal memory 6 or the external storage 7. The mail information stored in the internal memory 6 or the external storage 7 is read out. The above mail screen view is thereby displayed on the display 3 according to the read mail information. Further, when the navigation application is activated, the controller 2 outputs a navigation information read signal to the internal memory 6 or the external storage 7. The navigation information stored in the internal memory 6 or the external storage 7 is thereby read out. The map screen view described above is then displayed on the display 3 according to the read navigation information.

The speaker 8 is arranged at a position where the user can hear a speech in the vehicle cabin. When a speech command signal is received from the controller 2, a speech specified by the received speech command signal is outputted.

The microphone 9 is arranged at a position in the vehicle cabin at which a speech uttered by the user can be captured. When a speech uttered by the user is captured, a speech capture signal that can specify the captured speech is outputted to the controller 2. When the speech capture signal is received from the microphone 9, the controller 2 recognizes the speech specified by the received speech capture signal, and specifies the speech uttered by the user. For example, the controller 2 receives a speech capture signal from the microphone 9 in response to the user utters a speech of “KE”, “TU”, “TE”, and “I”, which signifies “determine” in English. The speech specified by the received speech capture signal is thereby recognized, and the speech uttered by the user is specified as “KE”, “TU”, “TE”, and “I”.

The controller 2 includes a first display control unit 2a, a second display control unit 2b, a rotation operation detection unit 2c, a determination operation detection unit 2d, a screen change detection unit 2e, and a processing execution unit 2f. The first display control unit 2a outputs the first display command signal described above to the first display unit 10 and controls the view (i.e., display) on the first display area 12. The second display control unit 2b outputs the above-described second display command signal to the second display unit 11, and controls the view on the second display area 13.

The rotation operation detection unit 2c receives the rotation operation detection signal described above from the operation switch 4 and detects a rotation operation performed on the second display area 13 by the user. The determination operation detection unit 2d receives the above-described speech capture signal from the microphone 9, and detects a determination operation performed by the user. The screen change detection unit 2e receives the screen change detection signal from the operation switch 4 and detects a screen change operation performed on the first display area 12 by the user.

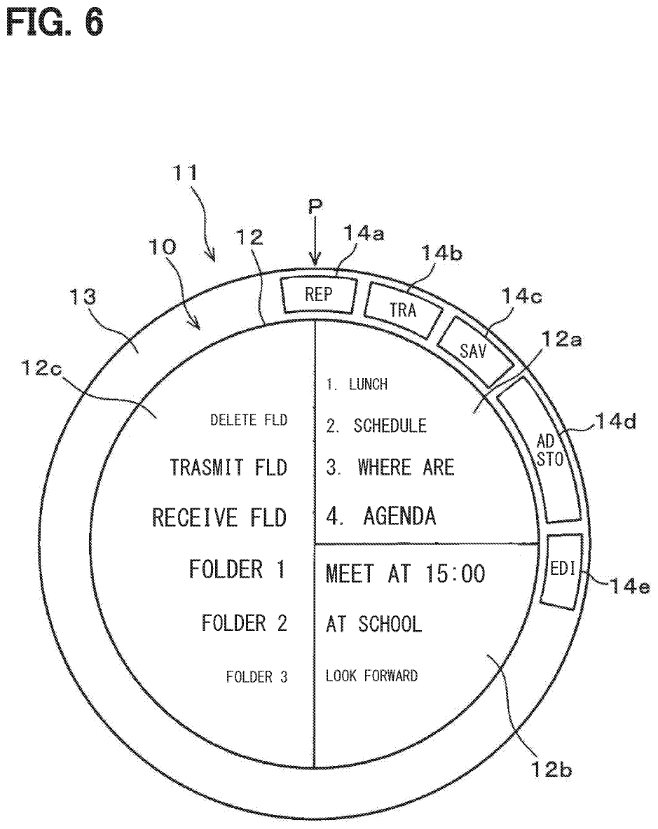

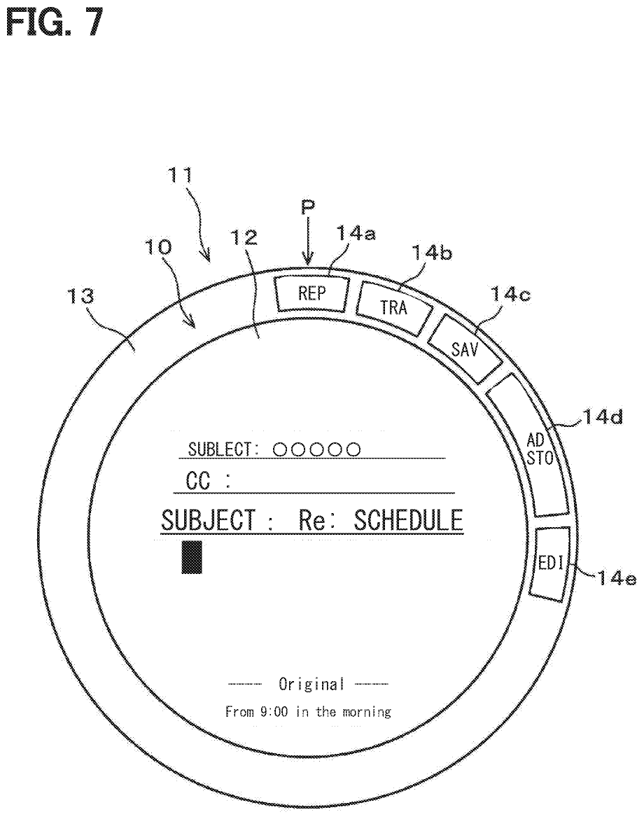

The processing execution unit 2f determines an item displayed at a predetermined position among a plurality of items displayed on the second display area 13 as a processing target item. The processing is executed according to the determined processing target item. More specifically, FIG. 6 shows a case where the mail application is activated and the reply icon 14a is displayed at the uppermost position of the second display area 13 (see “P” in FIG. 6, corresponding to a predetermined position). Here, in response to detecting that the user has uttered the speech of “KE”, “TU”, “TE”, and “i”, which signifies “determine” in English, the processing execution unit 2f determines the reply corresponding to the reply icon 14a as the processing target item. At this time, the first display control unit 2a outputs the first display command signal to the first display unit 10, and displays a reply screen view in which the user can perform a reply operation in the first display area 12, as shown in FIG. 7. The same applies to the case where it is detected that the user has uttered the speech of “KE”, “TU”, “TE”, and “I”, which signifies “determine” under the state where the transfer icon 14b, the save icon 14c, the address storage icon 14d, or the edit icon 14e is displayed at the uppermost position of the second display area 13. That is, the first display control unit 2a controls or causes the first display area 12 to display a transfer screen view, a save screen view, an address storage screen view, or an edit screen view, which can be operated by the user.

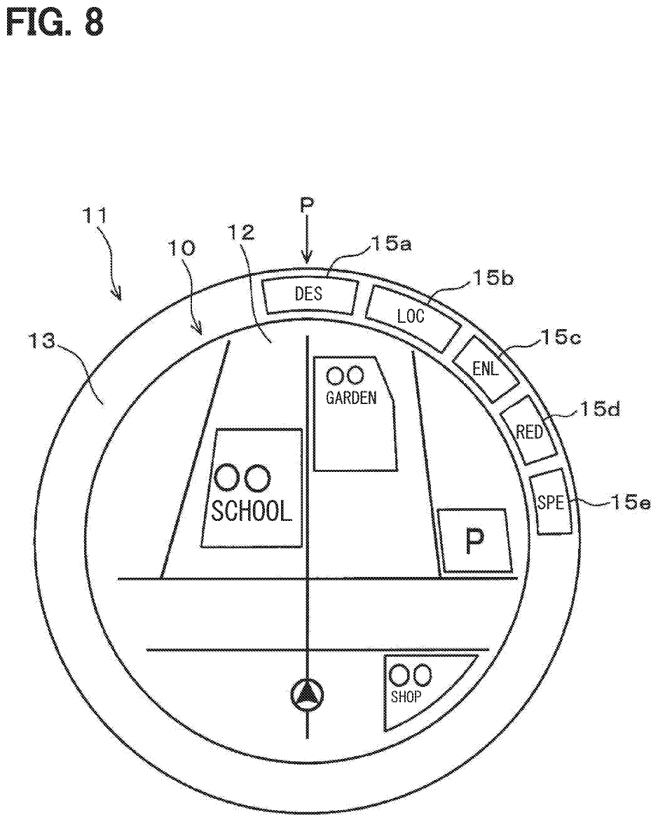

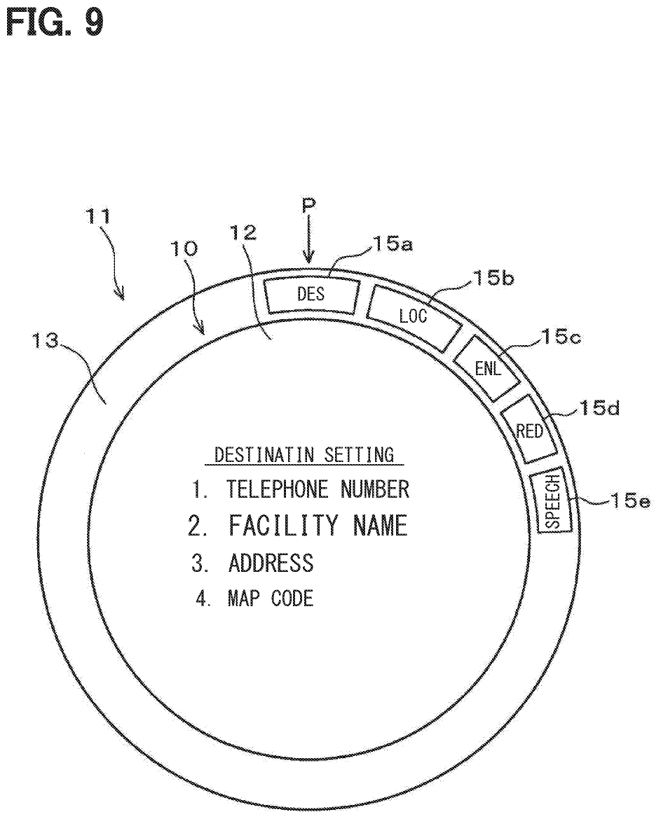

Suppose that the navigation application is activated and the destination icon 15a is displayed at the uppermost position of the second display area 13 (see “P” in FIG. 8). Herein, in response to detecting that the user has uttered the speech of “KE”, “TU”, “TE”, and “I”, which signifies “determine” in English, the processing execution unit 2f determines the destination setting corresponding to the destination icon 15a as the processing target item. At this time, the first display control unit 2a outputs a first display command signal to the first display unit 10. As shown in FIG. 9, a destination setting screen on which a user can perform a destination setting operation is displayed on the first display area 12. The same applies to the case where it is detected that the user has uttered a speech of “KE”, “TU”, “TE”, and “I”, which signifies “determine” in English, under the state where the current location icon 15b, the enlargement icon 15c, the reduction icon 15d, or the speech icon 15e is displayed at the uppermost position of the second display area 13. That is, the first display control unit 2a controls or causes the first display area 12 to display a current location display screen view, an enlargement display screen view, a reduction display screen view, or a speech guidance screen view, which can be operated by the user.

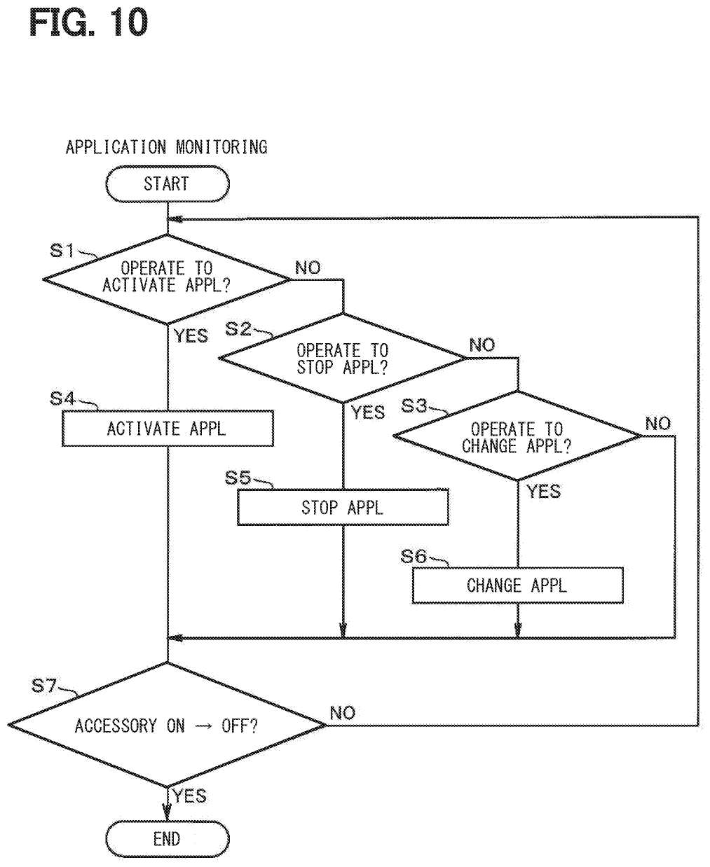

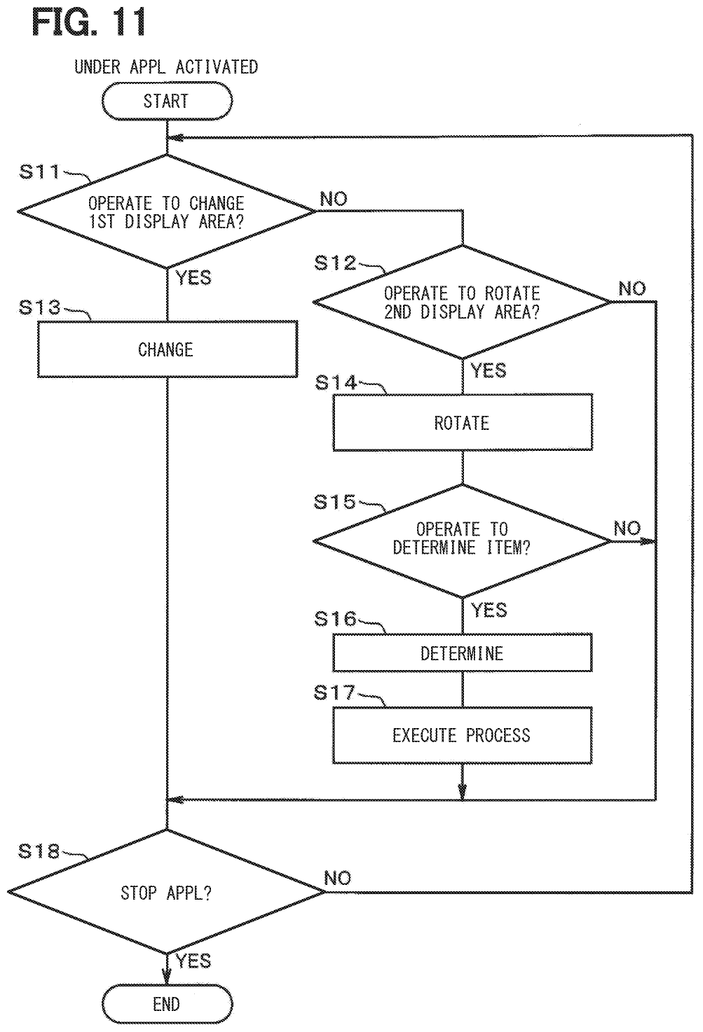

Next, the operation of the above configuration will be described with reference to FIGS. 10 and 11. In the vehicular display apparatus 1, for example, the controller 2 executes an application monitoring process when the accessory signal is ON, and executes a process under application activation while the application is activated. The following will describe each of the processes.

(1) Application Monitoring Process

When activating the application monitoring process, the controller 2 determines whether an activation operation for activating the application, a stop operation for stopping the application, or a change operation for changing the application, has been performed (S1 to S3). In this case, the user operates an application activation icon on a menu screen view (not shown) or utters a speech of “A”, “PU”, “RI”, “KU”, “DO”, “U”, which signifies “activate an application” in English, to thereby activate the application. In addition, the user can similarly perform a stop operation or a screen change operation for the application.

When the controller 2 determines that an activation operation for activating the application has been performed (S1: YES), the controller 2 activates the application specified by the activation operation (S4). That is, the controller 2 activates the mail application when an activation operation for activating the mail application is performed. As shown in FIG. 2 described above, the mail screen view is then displayed on the first display area 12, and various icons 14a to 14e are displayed on the second display area 13. Further, the controller 2 activates the navigation application when an activation operation for activating the navigation application is performed. As shown in FIG. 3 described above, a map screen view is displayed on the first display area 12 and various icons 15a to 15e are displayed on the second display area 13.

When the controller 2 determines that a stop operation for stopping the application has been performed (S2: YES), the controller 2 stops the application being activated at that time (S5). That is, if a stop operation is performed while the mail application is activated, the controller 2 stops the activated mail application. If a stop operation is performed while the navigation application is activated, the controller 2 stops the activated navigation application.

When the controller 2 determines that the change operation for changing the application has been performed (S3: YES), the controller 2 stops the activated application at that time. The application specified by the change operation is activated to change the applications (S6). That is, for example, when the change operation to the navigation application is performed while the mail application is activated, the controller 2 stops the activated mail application. The navigation application is then activated and the mail application is changed to the navigation application. The controller 2 determines whether the accessory signal is switched from ON to OFF (S7). As long as the accessory signal is ON, the controller 2 repeats the above steps S1 to S6. When the controller 2 determines that the accessory signal has been switched from ON to OFF, the controller 2 ends the application monitoring process.

(2) Process Under Application Activation

When activating the process under application activation, the controller 2 determines whether the user's screen change operation on the first display area 12 or the user's rotation operation on the second display area 13 has been performed (S11, S12). The controller 2 receives a screen operation detection signal from the operation switch 4 and determines that the user has performed a screen change operation (S11: YES). Thereby, the controller 2 outputs a first display command signal corresponding to the screen change operation to the first display unit 10, and switches the view on the first display area 12 according to the screen change operation (S13). That is, the controller 2 switches the mail screen view according to the screen change operation when the mail application is activated, and switches the map screen view according to the screen change operation when the navigation application is activated.

The controller 2 receives a rotation operation detection signal from the operation switch 4 and determines that the user has performed the rotation operation on the second display area 13 (S12: YES). Thereby, the controller 2 outputs a second display command signal corresponding to the rotation operation to the second display unit 11, and rotates the view of the item on the second display area 13 according to the rotation operation (S14, corresponding to a display control step). The controller 2 then determines whether the operation for determining the processing target item has been performed (S15). That is, the controller 2 rotates the view of the various icons 14a to 14e when the mail application is activated, while rotating the view of the various icons 15a to 15e when the navigation application is activated. It is then determined whether the operation of determining the processing target item has been performed.

The controller 2 detects, for example, that the user has uttered the speech “KE”, “TU”, “TE”, and “I”, which signifies “determine” in English, and determines that the operation to determine the processing target item has been performed (S15: YES). At that time, the item corresponding to the icon displayed at the uppermost position of the second display area 13 is determined as the processing target item (S16). Then, the controller 2 executes the processing according to the determined processing target item, and outputs a first display command signal to the first display unit 10. A screen view corresponding to the item determined as the processing target item is thereby displayed on the first display area 12 (S17, corresponding to a processing execution step).

That is, the user has uttered the speech of “KE”, “TU”, “TE”, and “I” while the mail application is activated and the reply icon 14a is displayed at the uppermost position of the second display area 13. Responsive to the detection thereof, as shown in FIG. 7, a reply screen view on which the user can perform a reply operation is displayed on the first display area 12. Further, the user has uttered the speech of “KE”, “TU”, “TE”, and “I” while the navigation application is activated and the destination icon 15a is displayed at the uppermost position of the second display area 13. Responsive to the detection thereof, as shown in FIG. 9, a destination setting screen view on which a user can perform a destination setting operation is displayed on the first display area 12. The controller 2 determines that the application is stopped (S18), and repeats the above steps S11 to S17 as long as the application is activated. When the controller 2 determines that the application has been stopped, the controller 2 ends the process under application activation.

The controller 2 performs the process described above, so that the user performs a rotation operation on the second display area 13 while keeping the line of sight fixed to the uppermost position of the second display area 13. Here, by uttering or pronouncing the speech of “KE”, “TU”, “TE”, and “I”, which signifies “determine” in English, while the desired icon is selected, it is possible to execute the processing corresponding to the selected desired icon. In other words, the user can select a desired icon with as little eye movement as possible even while driving. After ensuring safety, it is possible to execute the processing corresponding to the selected desired icon.

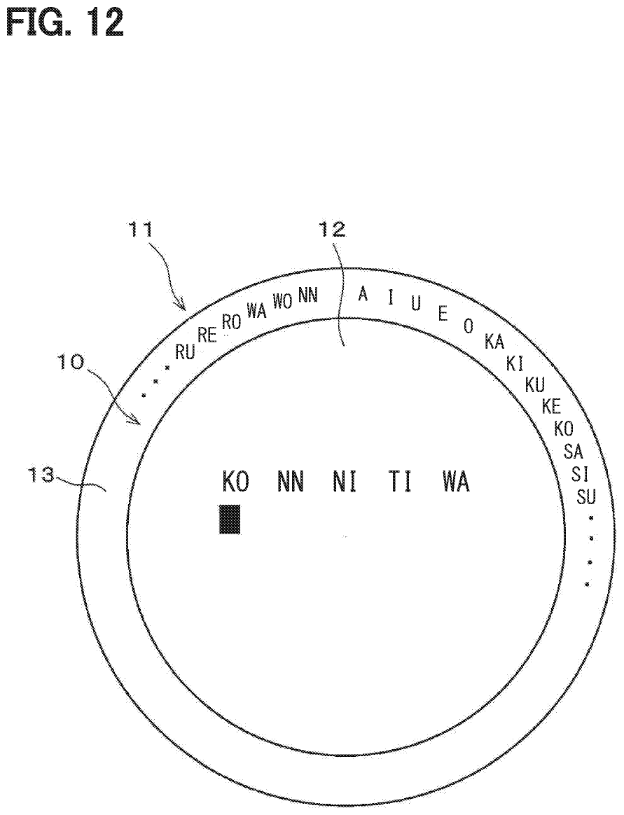

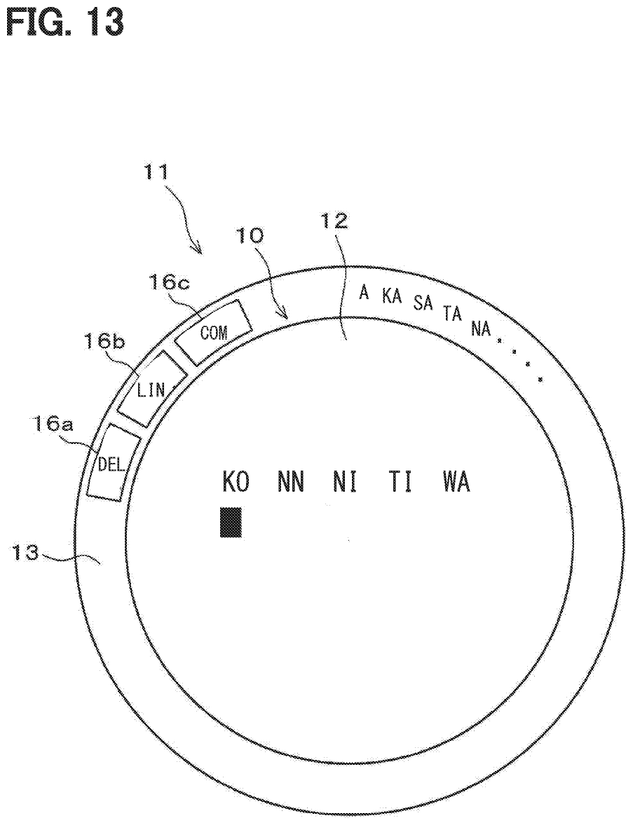

The above has described the case where a desired function is selected by selecting the icons 14a to 14e corresponding to the mail screen view or the icons 15a to 15e corresponding to the map screen view. The same applies to input of desired characters. That is, as shown in FIG. 12, a character input screen view is displayed on the first display unit 10. On the second display unit 11, the Japanese fifty character kana syllabary “A” to “NN” are displayed. The user may perform a rotation operation on the second display area 13 so that a desired character can be inputted to the character input screen view. In FIG. 12, “KO NN NI TI WA” which signifies “good morning” in English is displayed on the first display unit 10. Further, as shown in FIG. 13, another character input screen view is displayed on the first display unit 10. On the second display area 13, the rows of the Japanese syllabary “A”, “KA”, “SA”, . . . “WA” are displayed, together with a delete icon 16a (DEL), a linefeed icon 16b (LIN), a completion icon 16c (COM). A desired character can be inputted to the character input screen view by performing a rotation operation on the second display area 13 by the user. In addition, a desired icon may be selectable.

Also, the above has described the case where the user selects a desired icon and utters the speech of “KE”, “TU”, “TE”, and “I”, which signifies “determine” in English, to execute the processing corresponding to the selected desired icon. Instead of uttering the speech of “KE” “TU” “TE” and “I”, the operation switch in the steering wheel may be used. The user may operate an operation switch in the steering wheel to execute the processing corresponding to the selected desired icon. Also, the position where the user is holding the steering wheel may be detected by a camera or the like.

The processing corresponding to the selected desired icon may be executed by the user holding a predetermined position of the steering wheel.

The embodiment described above may provide effects as below. The user performs a rotation operation on the second display area 13 in the display apparatus 1 for a vehicle. In the second display area 13, a plurality of icons or characters thereby rotate along the outer periphery of the first display unit 10. The processing is executed according to the icon or character displayed at the uppermost position of the second display area 13 among the plurality of icons or characters. The user performs a rotation operation on the second display area 13 while keeping the line of sight fixed to the uppermost position of the second display area 13. A desired icon or character can thus be selected, and processing can be executed according to the selected desired icon or character. That is, even if the user is driving, it is possible to select a desired icon or character by minimizing the line of sight movement. In the configuration including the circle-shaped display 3, it is possible to enhance the usability when inputting characters or selecting functions.

In addition, the user utters the speech of “KE”, “TU”, “TE”, and “I”, which signifies “determine” in English, under the state where a desired icon or character is selected. Responsive thereto, the processing is executed according to the icon or character displayed at the uppermost position of the second display area 13 among the plurality of icons or characters. The user performs a rotation operation on the second display area 13 while keeping the line of sight fixed to the uppermost position of the second display area 13. After that, the speech of “KE”, “TU”, “TE” and “I” is uttered. With only this, the processing can be executed according to the selected desired icon or character.

In the first display unit 10, the density on displayed contents is relatively decreased on the center side, and the density on displayed contents is relatively increased on the peripheral side. That is, in the case of displaying a character, the character size is relatively increased on the center side to relatively decrease the density on characters, whereas the character size is relatively decreased on the peripheral side to relatively increase the density on characters. Further, in the case of displaying a map, the scale of the map is relatively large on the center side to make the density on map relatively small, whereas the scale of the map is relatively small on the peripheral side to make the density on map relatively large. This makes it easier for the user to recognize the information displayed on the center side than the information displayed on the peripheral side of the first display unit 10 (i.e., the first display area 12).

Although the present disclosure has been described in accordance with the embodiment, it is understood that the present disclosure is not limited to such an embodiment or structure. The present disclosure encompasses various modifications and variations within the scope of equivalents. In addition, various combinations and configurations, as well as other combinations and configurations that include only one element, more, or less, fall within the scope and spirit of the present disclosure.

The configuration to display the mail screen view corresponding to the mail application and the map screen view corresponding to the navigation application has been exemplified. The present disclosure can be applied to a case where another screen view corresponding to another application is displayed. For example, when activating an audio application, a play icon, a fast forward icon, a rewind icon, a pause icon, a volume up icon, a volume down icon, or the like may be selectable.

The configuration in which the uppermost position of the second display area 13 is the predetermined position has been exemplified. If the position is easy for the user to see, a position different from the uppermost position of the second display area 13 may be set as a predetermined position.

For reference to further explain features of the present disclosure, the description is added as follows.

Further, a character input apparatus is provided to permit a user to input a character by operating a touch panel to display the inputted character. This type of character input apparatus displays a rectangular array of a list of characters that can be inputted, such as Japanese (syllabary), alphabets, symbols, numbers. When the user selects a character, the selected character can be inputted.

In contrast, a circle-shaped display may be used for a display apparatus. If the above-mentioned rectangular array is applied to a circle-shaped display, there is arising a useless area. In contrast, a display apparatus having a circle-shaped display may provide a circular ring-shaped area surrounding the outer periphery of the circle-shaped display; the circular ring-shaped display displays rows of Japanese syllabary (“A” row, “KA” row, “SA” row, . . . ). In this case, after any one of rows of “A” row, “KA” row, “SA” row, . . . is selected, a character corresponding to “A” column, “I” column, “U” column, “E” column, “O” column of the selected row may be selected. That is, if a “KA” row is selected, “KA” column, “KI” column, “KU” column, “KE” column, and “KO” column are displayed as “A”, “I”, “U”, “E”, and “O” of the “KA” row. If “KI” is then selected, “KI” is inputted, for instance. The above-described configuration forces a line-of-sight movement to select a desired row or column. This may not be suitable for use in a vehicle. In addition, two stepwise operations of selecting a row and then selecting a column are required to make operations troublesome. Such an issue is not limited to inputting characters, but may also be assumed when selecting a mail function or a navigation function.

Under such circumstances, it is desired to improve usability when performing operations of character input or function selection.

An aspect of the present disclosure described herein is set forth in the following clauses.

According to an aspect of the present disclosure, a vehicular display apparatus is provided as including a first display unit, a second display unit, a second display control unit, a rotation operation detection unit, and a processing execution unit. The first display unit is configured to have a circle-shaped first display area to display a character input screen view. The second display unit is configured to have a circular ring-shaped second display area provided concentrically with the first display unit to surround an outer periphery of the first display unit. The second display control unit is configured to control a view on the second display area. The rotation operation detection unit is configured to detect a rotation operation by a user on the second display area. The processing execution unit is configured to perform processing according to a processing target item. Herein, in response to that the rotation operation is detected, the second display control unit is configured to rotate a view of a plurality of items displayed on the second display area along the outer periphery of the first display unit. The processing execution unit is configured to determine as the processing target item an item displayed at a predetermined position among the plurality of items displayed on the second display area, and to execute processing of inputting a character on the character input screen view according to the determined processing target item.

When a user performs a rotation operation on the circular ring-shaped second display area, the view of the plurality of items on the second display area rotates along the outer periphery of the circle-shaped first display area. The process is executed according to the item displayed at a predetermined position among the plurality of items. The user can select a desired item by performing a rotation operation on the second display area while keeping the line of sight fixed at the predetermined position. The processing can thus be executed according to the selected desired item. That is, even if the user is driving, it is possible to select a desired item by minimizing the line of sight movement. Such a configuration having a circle-shaped display area can improve the usability when performing operations of character input or function selection.

What is claimed is:

1. A vehicular display apparatus comprising:
a first display unit having a circle-shaped first display area to display a character input screen view;
a second display unit having a circular ring-shaped second display area provided concentrically with the first display unit to surround an outer periphery of the first display unit;
a second display control unit configured to control a view on the second display area;
a rotation operation detection unit configured to detect a rotation operation by a user on the second display area; and
a processing execution unit configured to perform processing according to a processing target item,
wherein:
in response to that the rotation operation is detected, the second display control unit is configured to rotate a view of a plurality of items displayed on the second display area along the outer periphery of the first display unit; and
the processing execution unit is configured
to determine as the processing target item an item displayed at a predetermined position among the plurality of items displayed on the second display area, and
to execute processing of inputting a character on the character input screen view according to the determined processing target item.

2. The vehicular display apparatus according to claim 1, wherein:
the second display control unit is configured to rotate a view of a plurality of icons as the plurality of items on the second display area along the outer periphery of the first display unit; and
the processing execution unit is configured
to determine an icon displayed at the predetermined position among the plurality of icons displayed on the second display area as a selection target, and
to execute the processing according to the determined selection target.

3. The vehicular display apparatus according to claim 1, wherein:
the second display control unit is configured to rotate a view of a plurality of characters as the plurality of items displayed on the second display area along the outer periphery of the first display unit; and
the processing execution unit is configured
to determine a character displayed at the predetermined position among the plurality of characters displayed on the second display area as an input target, and
to execute the processing according to the determined input target.

4. The vehicular display apparatus according to claim 1, further comprising:
a determination operation detection unit configured to detect a determination operation by the user,
wherein
in response to that the determination operation is detected, the processing execution unit is configured to determine the item displayed at the predetermined position among the plurality of items displayed on the second display area as the processing target item.

5. The vehicular display apparatus according to claim 1, further comprising:
a first display control unit configured to control a view on the first display area; and
a screen change detection unit configured to detect a screen change operation by the user on the first display area,
wherein
the first display control unit is configured to change the view displayed on the first display area in response to that the screen view change operation is detected.

6. The vehicular display apparatus according to claim 1, wherein
the first display control unit is configured
to make a density on displayed contents relatively lower on a center side of the first display unit, and
to make the density on displayed contents relatively higher on a periphery side of the first display unit.

7. The vehicular display apparatus according to claim 6, wherein
the displayed contents are characters;
the first display control unit is configured
to make a size of the character relatively larger by making the density on displayed characters relatively lower on the center side of the first display unit, and
to make the size of the character relatively smaller by making the density on displayed characters relatively higher on the periphery side of the first display unit.

8. The vehicular display apparatus according to claim 1, wherein:
the displayed contents are images; and
the first display control unit is configured
to make a scale of the image relatively larger by making the density on displayed images relatively lower on the center side of the first display unit, and
to make the scale of the image relatively smaller by making the density on displayed images relatively higher on the periphery side of the first display unit.

9. The vehicular display apparatus according to claim 1, wherein
the first display control unit is configured
to divide the first display area into a plurality of areas, and
to control a view of each of the divided areas.

10. A display apparatus comprising:
a display including (i) a circle-shaped first display area to display a character input screen view, and (ii) a circular ring-shaped second display area provided concentrically with the first display area to surround an outer periphery of the first display area; and
one or more controllers connected with the display via a communication link, the one or more controllers being configured
to rotate a view of a plurality of items displayed on the second display area along the outer periphery of the first display area in response to that a rotation operation to the second display area is detected,
to determine as a processing target item an item displayed at a predetermined position among the plurality of items displayed on the second display area, and
to execute processing of inputting a character on the character input screen view according to the determined processing target item.

11. A displaying method executed by a computer in a vehicular display apparatus with a display including (i) a circle-shaped first display area to display a character input screen view, and (ii) a circular ring-shaped second display area provided concentrically with the first display area to surround an outer periphery of the first display area, the method comprising:
rotating a view of a plurality of items displayed on the second display area along the outer periphery of the first display area in response to that a rotation operation to the second display area is detected;
determining as a processing target item an item displayed at a predetermined position among the plurality of items displayed on the second display area; and
executing processing of inputting a character on the character input screen view according to the determined processing target item.

12. A non-transitory computer-readable storage medium comprising a program product including instructions stored thereon for execution by a computer, the instructions including the displaying method according to claim 11, which is computer-implemented.
